(19) United States
(12) Patent Application Publication
(10) Pub. No.: US 2010/0317522 A1
(43) Pub. Date: Dec. 16, 2010

(54) Adjuvants for Agrochemical Applications

(75) Inventors: Benoit Abribat, Saint Fargeau Ponthierry (FR); Timothy Anderson, Hamilton, OK (US); Michael P. Pompeo, Fayetteville, GA (US)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/809,822

(22) PCT Filed: Dec. 12, 2008
(86) PCT No.: PCT/EP2008/010571

§ 371 Date: Aug. 30, 2010

Related U.S. Application Data
(60) Provisional application No. 61/015,723, filed on Dec. 21, 2007.

(51) Int. Cl. A01N 57/18; A01N 25/00; A01P 13/00

(52) U.S. Cl. 504/206; 504/358

(57) ABSTRACT

The invention is directed to an adjuvant composition for agrochemical formulations, the adjuvant composition comprising a salt of N-lauryl iminopropionic acid and an alkylamine derivative. Also provided is an agrochemical formulation, including an active agrochemical substance, a salt of N-lauryl iminopropionic acid, and an alkylamine derivative. Another aspect of the invention is directed to a method for making an adjuvant composition for an agrochemical formulation, including the steps of providing a salt of N-lauryl iminopropionic acid, and combining the salt of N-lauryl iminopropionic acid with an alkylamine derivative.

### FIELD OF THE INVENTION

The invention relates generally to adjuvants for agricultural applications, and more particularly, to adjuvants comprising a salt of N-Lauryl iminopropionic acid and an alkylamide derivative.

### BACKGROUND OF THE INVENTION

An agrochemical formulation conventionally includes an adjuvant to provide optimum activity of the active ingredient contained in the formulation. Adjuvants are used in pesticides to improve application for improved pest control. The addition of adjuvants also helps to reduce the amount of pesticide needed. Adjuvants are also used in plant growth regulators. Many adjuvants commercially available contain compounds that may be irritable to the eyes or skin. There remains a need for adjuvants for agrochemical applications, which avoid the disadvantages known from the state of the art. The problem underlying the present invention has been to develop a new adjuvant composition offering at least comparable performance when added to commercial agrochemical actives, how exhibit improved safety, especially with respect to eye and skin irritation.

### DETAILED DESCRIPTION OF THE INVENTION

A first embodiment of the present invention refers to an adjuvant composition for an agrochemical formulation, comprising:

(i) a salt of N-lauryl iminopropionic acid; and

(ii) an alkylamine derivative.

A second embodiment encompasses also an agrochemical formulation, comprising an active agrochemical substance; and
(i) a salt of N-lauryl iminopropionic acid; and
(ii) an alkylamine derivative.

Surprisingly it has been observed that blends comprising salts of N-lauryl iminopropionic acid an alkylamine derivatives show excellent adjuvant properties, however, are less skin and eye irritating when compared with standard products found in the market.

Agrochemical formulations include any compounds which contain active components from the group of fungicides, fertilizers, herbicides, pesticides, insecticides, plant strengthening agents or other active components for use in horticulture.

### Salts of N-Lauryl Iminopropionic Acid

The sodium salt of N-lauryl iminopropionic acid (compound a) may be prepared according to the general reaction scheme:

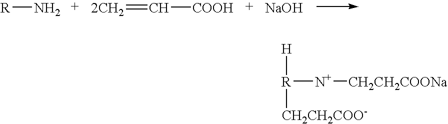

wherein R is a preferably coconut or other fatty acid residue, and the imino di-propionate is preferably partially neutralized (30-50% of imino-dipropionate in water). The alkylamine derivatives correspond to general formula (I):

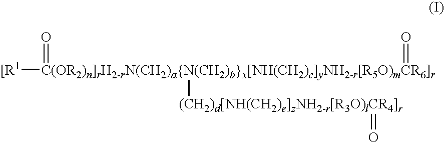

wherein R₁, R₄, and R₆ each independently represents hydrogen or a C₁₋₃₀ alkyl or alkenyl group; (OR₂)ₙ, (OR₃)₁, and (OR₅)ₙ each independently represents a random polyalkoxide group, a block polyalkoxide group, or a C₂₋₆ linear or branched, alkyl sulf(on)ate; R₂, R₃, and R₅ each independently represents a C₂₋₆ alkyl group; 1, m, and n, each independently represents a number from 1 to 100, r represents a number from 1 to 2; a, b, c, d, and e each independently represents a number from 1-12; and each of x, y, and z independently represent a number from 1-100.

### Alkylamine Derivatives

The alkylamine derivatives (Compound b) are obtained, for example, from a reaction of tallow or cocofatty acids with dimethyl amine, and thereafter are ethoxylated. Other methods for obtaining the alkylamine derivatives may also be available. The alkylamine derivatives suitable for the adjuvant compositions according to the invention include, but are not limited to: monoethanol amine, diethanol amine, triethanol amine, and a polyaliphatic amine and/or its derivatives. The salt of N-lauryl iminopropionic acid and an alkylamine derivative are mixed, in a suitable vessel, to form the composition. For example, coconut triglycerides (or fatty acids, inclulding medium chain triglycerides, and long chain fatty acids) are reacted with di-methyl amino propylamine (DMAP) to make a cocamidopropyl amine. The cocamidopropyl amine is further reacted with sodium chloroacetate to form a cocamidopropyl betaine. Advantageously, the adjuvant compositions exhibit reduced eye irritancy. In addition, the use of the adjuvant compositions according to an aspect of the invention provide for increased area per volume of liquid coverage of a selected area for treatment (with reduced need for active ingredient), and also to aid in allowing the active ingredient to wet the surface and penetrate the leaf barrier of a plant pathogen or the protective coating of an insect. Furthermore, the combination of an active ingredient, for example, glyphosate, with the adjuvant composition according to an aspect of the invention, increases the effect of the glyphosate, thus reducing the effective quantity of active ingredient needed. It is readily apparent that the reduced quantity of active ingredient needed has a positive effect on the environment.

### Adjuvant Compositions

The adjuvant compositions may be present in agrochemical formulations in ratios of 1:1 and 2:1, and also in ratios of 3:1 and 4:1, by weight of the adjuvant composition and the total agrochemical formulation. The adjuvant compositions may be used in combination with any active ingredient. The active ingredients which may be included in agrochemical formulations are preferably oil-soluble substances.

### Active Ingredients

The term “active ingredients” is used in the sense of a biocide. A biocide is a chemical substance capable of killing different forms of living organisms used in fields such as medicine, agriculture, forestry, and mosquito control. Usually, biocides are divided into two sub-groups:
pesticides, which includes fungicides, herbicides, insecticides, algicides, moluscicides, miticides and rodenticides, and
antimicrobials, which includes germicides, antibiotics, antibacterials, antivirals, antifungals, antiprotozoals and antiparasites.

Biocides can also be added to other materials (typically liquids) to protect the material from biological infestation and growth. For example, certain types of quaternary ammonium compounds (quats) can be added to pool water or industrial water systems to act as an algicide, protecting the water from infestation and growth of algae.

### Pesticides

The U.S Environmental Protection Agency (EPA) defines a pesticide as “any substance or mixture of substances intended for preventing, destroying, repelling, or mitigating any pest”.^{[1]} A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given:

Fungicides. A fungicide is one of three main methods of pest control—the chemical control of fungi in this case. Fungicides are chemical compounds used to prevent the spread of fungi in gardens and crops. Fungicides are also used to fight fungal infections. Fungicides can either be contact or systemic. A contact fungicide kills fungi when sprayed on its surface. A systemic fungicide has to be absorbed by the fungus before the fungus dies. Examples for suitable fungicides, according to the present invention, encompass the following species: (3-ethoxypropyl)mercury bromide, 2-methoxyethylmercury chloride, 2-phenylphenol, 8-hydroxyquinoline sulfate, 8-phenylmercurioxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulfon, dinoterbon, diphenylamine, dipyrithione, disulfuram, ditalimfos, dithianon, dithiocarbamate fungicides, DNOC, dodemorph, dodicin, dodine, DONATODINE, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, flumorph, fluopicolide, fluoroimide, fluotrimazole, fluoxastrobin, fluquinconazole, flusilazole, flusulfamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulfide, spiroxamine, streptomycin, strobilurin fungicides, sulfonanilide fungicides, sulfur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide and their mixtures.

Herbicides. An herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are nonselective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat. In the following, a number of suitable herbicides are compiled:
2,4-D, a broadleaf herbicide in the phenoxy group used in turf and in no-till field crop production. Now mainly used in a blend with other herbicides that act as synergists, it is the most widely used herbicide in the world, third most commonly used in the United States. It is an example of synthetic auxin (plant hormone).
Atrazine, a triazine herbicide used in corn and sorghum for control of broadleaf weeds and grasses. It is still used because of its low cost and because it works as a synergist when used with other herbicides, it is a photosystem II inhibitor.
Clopyralid, a broadleaf herbicide in the pyridine group, used mainly in turf, rangeland, and for control of noxious thistles. Notorious for its ability to persist in compost. It is another example of synthetic auxin.
Dicamba, a persistent broadleaf herbicide active in the soil, used on turf and field corn. It is another example of synthetic auxin.
Glyphosate, a systemic nonselective (it kills any type of plant) herbicide used in no-till burndown and for weed control in crops that are genetically modified to resist its effects. It is an example of a EPSPs inhibitor.
Imazapyr, a non-selective herbicide used for the control of a broad range of weeds including terrestrial annual and perennial grasses and broadleaved herbs, woody species, and riparian and emergent aquatic species.
Imazapic, a selective herbicide for both the pre- and post-emergent control of some annual and perennial grasses and some broadleaf weeds. Imazapic kills plants by inhibiting the production of branched chain amino acids (valine, leucine, and isoleucine), which are necessary for protein synthesis and cell growth.
Metoalachlor, a pre-emergent herbicide widely used for control of annual grasses in corn and sorghum; it has largely replaced atrazine for these uses.
Paraquat, a nonselective contact herbicide used for no-till burndown and in aerial destruction of marijuana and coca plantings. More acutely toxic to people than any other herbicide in widespread commercial use.
Picloram, a pyridine herbicide mainly used to control unwanted trees in pastures and edges of fields. It is another synthetic auxin.
Triclopyr.

Insecticides. An insecticide is a pesticide used against insects in all developmental forms. They include ovicides and larvicides used against the eggs and larvae of insects. Insecticides are used in agriculture, medicine, industry and the household. In the following, suitable insecticides are mentioned:
Chlorinated insecticides such as, for example, Camphechlor, DDT, Hexachlorocyclohexane, gamma-Hexachlorocyclohexane, Methoxychlor, Pentachlorophenol, TDE, Aldrin, Chlordane, Chlordecone, Dieldrin, Endosulfan, Endrin, Heptachlor, Mirex and their mixtures;
Organophosphorus compounds such as, for example, Acephate, Azinphos-methyl, Bensulide, Chlorethoxyfos, Chlorpyrifos, Chlorpyriphos-methyl, Diazinon, Dichlorvos (DDVP), Dicrotophos, Dimethoate, Disulfoton, Ethoprop, Fenamiphos, Fenitrothion, Fenthion, Fosthiazate, Malathion, Methamidophos, Methidathion, Methyl-parathion, Mevinphos, Naled, Omethoate, Oxydemeton-methyl, Parathion, Phorate, Phosalone, Phosmet, Phostebupirim, Pirimiphos-methyl, Profenofos, Terbufos, Tetrachlorvinphos, Tribufos, Trichlorfon and their mixture;
Carbamates such as, for example, Aldicarb, Carbofuran, Carbaryl, Methomyl, 2-(1-Methylpropyl)phenyl methylcarbamate and their mixtures;
Pyrethroids such as, for example, Allethrin, Bifenthrin, Deltamethrin, Permethrin, Resmethrin, Sumithrin, Tetramethrin, Tralomethrin, Transfluthrin and their mixtures;
Plant toxin derived compounds such as, for example, Denis (rotenone), Pyrethrum, Neem (Azadirachtin), Nicotine, Caffeine and their mixtures.

Rodenticides. Rodenticides are a category of pest control chemicals intended to kill rodents. Rodents are difficult to kill with poisons because their feeding habits reflect their place as scavengers. They would eat a small bit of something and wait, and if they do not get sick, they would continue eating. An effective rodenticide must be tasteless and odorless in lethal concentrations, and have a delayed effect. In the following, examples for suitable rodenticides are given:
Anticoagulants are defined as chronic (death occurs after 1-2 weeks post ingestion of the lethal dose, rarely sooner), single-dose (second generation) or multiple dose (first generation) cumulative rodenticides. Fatal internal bleeding is caused by lethal dose of anticoagulants such as brodifacoum, coumatetralyl or warfarin. These substances in effective doses are antivitamins K, blocking the enzymes K₁-2,3-epoxide-reductase (this enzyme is preferentially blocked by 4-hydroxycoumarin/4-hydroxythiacoumarin derivatives) and K₁-quinone-reductase (this enzyme is preferentially blocked by indandione derivatives), depriving the organism of its source of active vitamin K₁. This leads to a disruption of the vitamin K cycle, resulting in an inability of production of essential blood-clotting factors (mainly coagulation factors II (prothrombin), VII (proconvertin), IX (Christmas factor) and X (Stuart factor)). In addition to this specific metabolic disruption, toxic doses of 4-hydroxycoumarin/4-hydroxythiacoumarin and indandione anticoagulants are causing damage to tiny blood vessels (capillaries), increasing their permeability, causing diffuse internal bleedings (haemorrhagias). These effects are gradual; they develop in the course of days and are not accompanied by any nociceptive perceptions, such as pain or agony. In the final phase of intoxication the exhausted rodent collapses in hypovolemic circulatory shock or severe anemia and dies calmly. Rodenticidal anticoagulants are either first generation agents (4-hydroxycoumarin type: warfarin, coumatetralyl; indandione type: pindone, diphacinone, chlorophacinone), generally requiring higher concentrations (usually between 0.005 and 0.1%), consecutive intake over days in order to accumulate the lethal dose, poor active or inactive after single feeding and less toxic than second generation agents, which are derivatives of 4-hydroxycoumarin (difenacoum, brodifacoum, bromadiolone and flocoumafen) or 4-hydroxy-1-benzothiin-2-one (4-hydroxy-1-thiacoumarin, sometimes incorrectlly referred to as 4-hydroxy-1-thiocoumarin, for reason see heterocyclic compounds), namely difethialone. Second generation agents are far more toxic than first generation agents, they are generally applied in lower concentrations in baits (usually in the order of 0.001-0.005%), and are lethal after single ingestion of bait and are effective also against strains of rodents that have become resistant against first generation anticoagulants; thus the second generation anticoagulants are sometimes referred to as “superwarfarins”. Sometimes, anticoagulant rodenticides are potentiated by an antibiotic, most commonly by sulfaquinoxaline. The aim of this association (e.g. warfarin 0.05%+sulfaquinoxaline 0.02%, or difenacoum 0.005%+sulfaquinoxaline 0.02% etc.) is that the antibiotic/bacteriostatic agent suppresses intestinal/gut symbiotic microflora that represents a source of vitamin K. Thus the symbiotic bacteria are killed or their metabolism is impaired and the production of vitamin K by them is diminuted, an effect which logically contributes to the action of anticoagulants. Antibiotic agents other than sulfaquinoxaline may be used, for example co-trimoxazole, tetracycline, neomycin or metronidazole. A further synergism used in rodenticidal baits is that of an association of an anticoagulant with a compound with vitamin D-activity, i.e. cholecalciferol or ergocalciferol (see below). A typical formula used is, e.g., warfarin 0.025-0.05%+cholecalciferol 0.01%. In some countries there are even fixed three-component rodenticides, i.e. anticoagulant+antibiotic+vitamin D, e.g. difenacoum 0.005%+sulfaquinoxaline 0.02%+cholecalciferol 0.01%. Associations of a second-generation anticoagulant with an antibiotic and/or vitamin D are considered to be effective even against the most resistant strains of rodents, though some second generation anticoagulants (namely brodifacoum and difethialone), in bait concentrations of 0.0025-0.005% are so toxic that no known resistant strain of rodents exists and even rodents resistant against any other derivatives are reliably exterminated by application of these most toxic anticoagulants.

Vitamin K₁ has been suggested and successfully used as an antidote for pets or humans, which/who were either accidentally or intentionally (poison assaults on pets, suicidal attempts) exposed to anticoagulant poisons. In addition, since some of these poisons act by inhibiting liver functions and in progressed stages of poisoning, several blood-clotting factors as well as the whole volume of circulating blood lacks, a blood transfusion (optionally with the clotting factors present) can save a person's life who inadvertently takes them, which is an advantage over some older poisons.
Metal phosphides have been used as a means of killing rodents and are considered single-dose fast acting rodenticides (death occurs commonly within 1-3 days after single bait ingestion). A bait consisting of food and a phosphide (usually zinc phosphide) is left where the rodents can eat it. The acid in the digestive system of the rodent reacts with the phosphide to generate the toxic phosphine gas. This method of vermin control has possible use in places where rodents are resistant to some of the anticoagulants, particularly for control of house and field mice; zinc phosphide baits are also cheaper than most second-generation anticoagulants, so that sometimes, in cases of large infestation by rodents, their population is initially reduced by copious amounts of zinc phosphide bait applied, and the rest of the population that survived the initial fast-acting poison is then eradicated by prolonged feeding on anticoagulant bait. Inversely, the individual rodents that survived anticoagulant bait poisoning (rest population) can be eradicated by pre-baiting them with nontoxic bait for a week or two (this is important to overcome bait shyness, and to get rodents used to feeding in specific areas by offering specific food, especially when eradicating rats) and subsequently applying poisoned bait of the same sort as used for pre-baiting until all consumption of the bait ceases (usually within 2-4 days). These methods of alternating rodenticides with different modes of action provides a factual or an almost 100% eradication of the rodent population in the area if the acceptance/palatability of bait is good (i.e., rodents readily feed on it).
Phosphides are rather fast acting rat poisons, resulting in that the rats are dying usually in open areas instead of the affected buildings. Typical examples are aluminum phosphide (fumigant only), calcium phosphide (fumigant only), magnesium phosphide (fumigant only) and zinc phosphide (in baits). Zinc phosphide is typically added to rodent baits in amounts of around 0.75-2%. The baits have a strong, pungent garlic-like odor characteristic for phosphine liberated by hydrolysis. The odor attracts (or, at least, does not repulse) rodents, but has a repulsive effect on other mammals; birds, however (notably wild turkeys), are not sensitive to the smell and feed on the bait thus becoming collateral damage.
Hypercalcemia. Calciferols (vitamins D), cholecalciferol (vitamin D₃) and ergocalciferol (vitamin D₂) are used as rodenticides, which are toxic to rodents for the same reason that they are beneficial to mammals: they are affecting calcium and phosphate homeostasis in the body. Vitamins D are essential in minute quantities (few IUs per kilogram body weight daily, which is only a fraction of a milligram), and like most fat soluble vitamins they are toxic in larger doses as they readily result in the so-called hypervitaminosis, which is, simply said, poisoning by the vitamin. If the poisoning is severe enough (that is, if the dose of the toxicant is high enough), it eventually leads to death. In rodents consuming the rodenticidal bait it causes hypercalcemia by raising the calcium level, mainly by increasing calcium absorption from food, mobilising bone-matrix-fixed calcium into ionised form (mainly monohydrogencarbonate calcium cation, partially bound to plasma proteins, [CaHCO₃]⁺), which circulates dissolved in the blood plasma, and after ingestion of a lethal dose the free calcium levels are raised sufficiently so that blood vessels, kidneys, the stomach wall and lungs are mineralised/calcificated (formation of calcificates, crystals of calcium salts/complexes in the tissues thus damaging them), leading further to heart problems (myocard is sensitive to variations of free calcium levels that are affecting both myocardial contractibility and excitation propagation between atrias and ventriculas) and bleeding (due to capillary damage) and possibly kidney failure. It is considered to be single-dose, or cumulative (depending on concentration used; the common 0.075% bait concentration is lethal to most rodents after a single intake of larger portions of the bait), sub-chronic (death occurring usually within days to one week after ingestion of the bait). Applied concentrations are 0.075% cholecalciferol and 0.1% ergocalciferol when used alone. There is an important feature of calciferols toxicology which is that they are synergistic with anticoagulant toxicants. This means that mixtures of anticoagulants and calciferols in the same bait are more toxic than the sum of toxicities of the anticoagulant and the calciferol in the bait so that a massive hypercalcemic effect can be achieved by substantially lower calciferol content in the bait and vice-versa. More pronounced anticoagulant/hemorrhagic effects are observed if calciferol is present. This synergism is mostly used in baits low in calciferol because effective concentrations of calciferols are more expensive than effective concentrations of most anticoagulants. The historically very first application of a calciferol in rodenticidal bait was, in fact, the Sorex product Sorexa® D (with a different formula than today's Sorexa® D) back in the early 1970's, containing warfarin 0.025%+ergocalciferol 0.1%. Today, Sorexa® CD contains a 0.0025% difenacoum+0.075% cholecalciferol combination. Numerous other brand products containing either calciferols 0.075-0.1% (e.g. Quintox®, containing 0.075% cholecalciferol) alone, or a combination of calciferol 0.01-0.075% with an anticoagulant are marketed.

### Miticides, Moluscicides and Nematicides.

Miticides are pesticides that kill mites. Antibiotic miticides, carbamate miticides, formamidine miticides, mite growth regulators, organochlorine, permethrin and organophosphate miticides all belong to this category.
Molluscicides are pesticides used to control mollusks, such as moths, slugs and snails. These substances include metaldehyde, methiocarb and aluminium sulfate. A nematicide is a type of chemical pesticide used to kill parasitic nematodes (a phylum of worm).
A nematicide is obtained from a neem tree's seed cake; which is the residue of neem seeds after oil extraction. The neem tree is known by several names in the world but was first cultivated in India since ancient times.

### Antimicrobials

In the following examples, antimicrobials suitable for agrochemical compositions according to the present invention are given. Bactericidal disinfectants mostly used are those applying
active chlorine (i.e., hypochlorites, chloramines, dichloroisocyanurate and trichloroisocyanurate, wet chlorine, chlorine dioxide, etc.),
active oxygen (peroxides such as peracetic acid, potassium persulfate, sodium perborate, sodium percarbonate and urea perhydrate),
iodine (iodpovidone (povidone-iodine, Betadine), Lugol's solution, iodine tincture, iodinated nonionic surfactants),
concentrated alcohols (mainly ethanol, 1-propanol, called also n-propanol and 2-propanol, called isopropanol and mixtures thereof; further, 2-phenoxyethanol and 1- and 2-phenoxypropanols are used),
phenolic substances (such as phenol (also called “carbolic acid”), cresols (called “Lysole” in combination with liquid potassium soaps), halogenated (chlorinated, brominated) phenols, such as hexachlorophene, triclosan, trichlorophenol, tribromophenol, pentachlorophenol, Dibromol and salts thereof),
cationic surfactants such as some quaternary ammonium cations (such as benzalkonium chloride, cetyl trimethylammonium bromide or chloride, didecyldimethylammonium chloride, cetylpyridinium chloride, benzethonium chloride) and others, non-quarternary compounds such as chlorhexidine, glucoprotamine, octenidine dihydrochloride, etc.),
strong oxidizers such as ozone and permanganate solutions;
heavy metals and their salts such as colloidal silver, silver nitrate, mercury chloride, phenylmercury salts, copper sulfate, copper oxide-chloride etc. Heavy metals and their salts are the most toxic and environmentally hazardous bactericides and, therefore, their use is strongly suppressed or forbidden; further, also
properly concentrated strong acids (phosphoric, nitric, sulfuric, amidosulfuric, toluenesulfonic acids) and
alcalis (sodium, potassium, calcium hydroxides) between pH<1 or >13, particularly below elevated temperatures (above 60° C.) kill bacteria.

As antiseptics (i.e., germicide agents that can be used on human or animal body, skin, mucoses, wounds and the like), few of the above mentioned disinfectants can be used under proper conditions (mainly concentration, pH, temperature and toxicity toward man/animal). Among them, important are
Some properly diluted chlorine preparations (e.g. Daquin's solution, 0.5% sodium or potassium hypochlorite solution, pH-adjusted to pH 7-8, or 0.5-1% solution of sodium benzenesulfochloramide (chloramine B)), some
iodine preparations such as iodopovidone in various galenics (ointments, solutions, wound plasters), in the past also Lugol's solution,
peroxides as urea perhydrate solutions and pH-buffered 0.1-0.25% peracetic acid solutions,
alcohols with or without antiseptic additives, used mainly for skin antisepsis,
weak organic acids such as sorbic acid, benzoic acid, lactic acid and salicylic acid
some phenolic compounds such as hexachlorophene, triclosan and Dibromol, and
cation-active compounds such as 0.05-0.5% benzalkonium, 0.5-4% chlorhexidine, 0.1-2% octenidine solutions.

Bactericidal antibiotics kill bacteria; bacteriostatic antibiotics only slow down their growth or reproduction. Penicillin is a bactericide, as are cephalosporins. Aminoglycosidic antibiotics can act in both a bactericidic manner (by disrupting cell wall precursor leading to lysis) or bacteriostatic manner (by connecting to 30s ribosomal subunit and reducing translation fidelity leading to inaccurate protein synthesis). Other bactericidal antibiotics according to the present invention include the fluoroquinolones, nitrofurans, vancomycin, monobactams, co-trimoxazole, and metronidazole.

### Glyphosate

The preferred agrochemical actives, however, is Glyphosate (═N-(phosphonomethyl)glycine), C₃H₈NO₅P, MW 169.07, melting point 200° C., LD₅₀ (rat, oral) 4320 mg/kg (WHO), a nonselective systemic leaf herbicide which is used in the form of its isopropylamine salt for the total and semitotal control of unwanted grasses and weeds, including deep-rooting several-year-old species, among all agricultural crops, in orchards and vineyards. The structure of glyphosate is as follows:

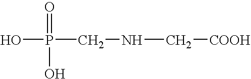

It should be understood that the term glyphosate includes all glyphosate derivatives, including mono- or diethanolamine salts of glyphosate. Sodium and potassium are also suitable cations. The isopropylamine salt of glyphosate is particularly suitable. In addition, mixtures of these compounds may also be used for the purposes of the invention.

### Auxiliaries and Additives

The agrochemical formulations may contain auxiliaries and additives. Additional adjuvants may also be present. For example, the nonionic surfactants selected from at least one of the following groups are suitable according to an aspect of the invention:

### Emulsifiers

Suitable emulsifiers can be derived from the following groups of non-ionic surfactants.
products of the addition of 2 to 120 mol ethylene oxide and/or 0 to 75 mol propylene oxide onto linear fatty alcohols containing 8 to 22 carbon atoms, fatty amines, onto fatty acids containing 8 to 22 carbon atoms, onto alkylphenols containing 8 to 15 carbon atoms in the alkyl group and C₆₋₂₂ fatty amines;
C_{12/18} fatty acid monoesters, diesters and triesters of products of the addition of 1 to 120 mol ethylene oxide onto glycerol and technical oligoglycerols;
glycerol monoesters and diesters and sorbitan monoesters and diesters of saturated and unsaturated fatty acids containing 6 to 22 carbon atoms and ethylene oxide adducts thereof;
alkyl mono- and oligoglycosides containing 8 to 22 carbon atoms in the alkyl group and ethoxylated analogs thereof;
products of the addition of 15 to 60 mol ethylene oxide onto castor oil and/or hydrogenated castor oil;
polyol esters and, in particular, polyglycerol esters such as, for example, polyglycerol polyricinoleate or polyglycerol poly-12-hydroxystearate. Mixtures of compounds from several of these classes are also suitable;
products of the addition of 2 to 15 mol ethylene oxide onto castor oil and/or hydrogenated castor oil;
partial esters based on linear, branched, unsaturated or saturated C_{6/22} fatty acids, ricinoleic acid and 12-hydroxystearic acid and glycerol, polyglycerol, pentaerythritol, dipentaerythritol, sugar alcohols (for example sorbitol), alkyl glucosides (for example methyl glucoside, butyl glucoside, lauryl glucoside) and polyglucosides (for example cellulose);
trialkyl phosphates and mono-, di- and/or tri-PEG-alkyl phosphates and salts thereof;
wool wax alcohols;
polysiloxane/polyalkyl polyether copolymers and corresponding derivatives;
mixed esters of pentaerythritol, fatty acids, citric acid and fatty alcohol and/or mixed esters of fatty acids containing 6 to 22 carbon atoms, methyl glucose and polyols, preferably glycerol;
polyalkylene glycols; and
glycerol carbonate.

### Solvents

Non-polar solvents may also be added, particularly with respect to pesticides or other agrochemical compounds that are solid at room temperature. Suitable non-polar solvents include, but are not limited to: mineral oils, aromatic alkyl compounds and the hydrocarbons marketed, for example, under the name of Solvesso® by Exxon, fatty acid lower alkyl esters, for example, methyl, ethyl, propyl and/or butyl esters, of caproic acid, caprylic acid, 2-ethylhexanoic acid, capric acid, lauric acid, isotridecanoic acid; myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Other suitable solvents include vegetable triglycerides, for example, coconut oil, palm oil, palm kernel oil, sunflower oil, and olive oil. Another suitable solvent includes polyethylene glycol, preferably with molecular weights ranging from 90 to 600, and also ranging from 120 to 250.

Ready-to-use agrochemical formulations generally have water content of on average 10 to 90% by weight and more particularly 30 to 60% by weight. The formulations may include the active component in quantities of 0.01 to 5% by weight, preferably in quantities of 0.1 to 2.5% by weight and more particularly in quantities of 0.1 to 1.5% by weight. The agrochemical formulations may also be formulated as concentrates, for example containing 10 to 90% by weight of the active component, whereby the actual in-use concentration is selected by diluting the concentrate. The water content in such concentrates may be between about 1 and 30% by weight. The adjuvant composition may also include an ethoxylated alcohol or alkylamine, a polyhydric alcohol, and defoamer. Other conventional additives that do not materially affect the basic characteristics and efficacy of the composition may also be present. Unless otherwise defined, all technical and scientific terms used herein have the same meaning commonly understood by one of ordinary skill in the art to which the invention belongs. Although methods and materials similar or equivalent to those described herein can be used in the practice or testing of the invention, suitable methods and materials are described below. The materials, methods and examples are illustrative only, and are not intended to be limiting.

### INDUSTRIAL APPLICATION

The present invention also encompasses a method for making an adjuvant composition for an agrochemical formulation, comprising the steps of:
(a) providing a salt of N-lauryl iminopropionic acid; and
(b) combining the salt of N-lauryl iminopropionic acid with an alkylamine derivative.

In a preferred embodiment an active ingredient is added to the adjuvant composition.

### EXAMPLES

### Examples 1 to 3

The following compositions were tested for efficacy as enhancers of weed control when formulated with Glyphosate herbicide. These formulas were tested by spraying 10 foot by 30 foot plots of ground that had been seeded with both weed seeds as well as soybeans. After approximately 20 days after germination, the entire plots were sprayed with a glyphosate/surfactant/water solution. The effect of the spray solution on weed control was documented by visual observations made by trained field biologists at 7, 14 and 28 days after treatment. All formulas below provided weed control equal to the standard RoundUp® Ultra spray solutions, available from Monsanto. The compositions are compiled in Table 1.

TABLE 1
Adjuvant compositions (% b.w.)

| Composition | 1 | 2 | 3 |
|---|---|---|---|
| Isopropylamine salt of Glyphosate | 66.00 | 66.00 | 66.00 |
| (62% active matter) | | | |
| Emery ® 6717L | 9.45 | 11.50 | — |
| Polyetheyleneimine 1200C5-C10 amide | | | |
| Deriphat ® 160C | 1.05 | 2.85 | 0.50 |
| Cocoamidopropyl betaine (35% active matter) | | | |
| Glycerol | 2.00 | — | 6.00 |
| Propylene glycol | 2.00 | — | |
| Monoethanolamine | — | — | 1.50 |
| Agnique ® DFM 111s | 0.05 | 0.05 | 0.05 |
| Defoamer | | | |
| Agnique ® TAM-20 | — | — | 5.50 |
| Tallow amine POE20 | | | |

| | |
|---|---|
| Water | ad 100 |

1. An adjuvant composition for an agrochemical formulation, comprising:
(i) a salt of N-lauryl iminopropionic acid; and
(ii) an alkylamine derivative.

2. An agrochemical formulation, comprising an active agrochemical substance and the adjuvant composition of claim 1.

3. A method for making an adjuvant composition for an agrochemical formulation, comprising the steps of:
(a) providing a salt of N-lauryl iminopropionic acid; and
(b) combining the salt of N-lauryl iminopropionic acid with an alkylamine derivative.

4. The method of claim 3, further comprising the step of:
(c) adding an agrochemical active ingredient to said adjuvant composition.

5. The adjuvant composition of claim 1, wherein said alkylamine derivative (ii) comprises at least one compound of formula (I): 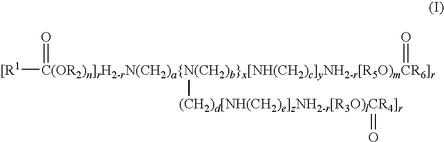
wherein R₁, R₄, and R₆ independently represent hydrogen or a C₁₋₃₀ alkyl or C₁₋₃₀ alkenyl group; (OR₂)ₙ, (OR₃)₁, and (OR₅)₅ independently represent a random polyalkoxide group, a block polyalkoxide group, or a C₂₋₆ linear or branched, alkyl sulf(on)ate; R₂, R₃, and R₅ independently represent a C₂₋₆ alkyl group; l, m, and n, independently represent a number from 1 to 100, r represents a number from 1 to 2; a, b, c, d, and e independently represent a number from 1-12; and x, y, and z independently represent a number from 1-100.

6. The method of claim 3, wherein said alkylamine derivative (ii) comprises at least one compound of formula (I): 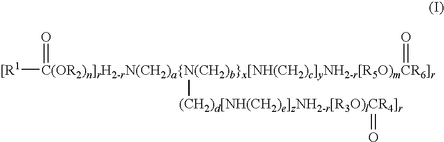
wherein R₁, R₄, and R₆ independently represent hydrogen or a C₁₋₃₀ alkyl or C₁₋₃₀ alkenyl group;
(OR₂)ₙ, (OR₃)₁, and (OR₅)ₙ independently represent a random polyalkoxide group, a block polyalkoxide group, or a C₂₋₆ linear or branched, alkyl sulf(on)ate; R₂, R₃, and R₅ independently represent a C₂₋₆ alkyl group; l, m, and n, independently represent a number from 1 to 100, r represents a number from 1 to 2; a, b, c, d, and e independently represent a number from 1-12; and x, y, and z independently represent a number from 1-100.
